(19) United States
(12) Patent Application Publication
(10) Pub. No.: US 2008/0253472 A1
(43) Pub. Date: Oct. 16, 2008

(54) Uart-Encoded Pulse-Modulation Technique

(75) Inventor: Pieter Dingenis Griep, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,192

(22) PCT Filed: May 25, 2005
(86) PCT No.: PCT/IB05/51703

§ 371 Date: Nov. 16, 2006

(30) Foreign Application Priority Data
May 28, 2004 (EP) 04102380.5

(51) Int. Cl. H04L 27/00

(52) U.S. Cl. 375/295

(57) ABSTRACT

The settings of a UART-based infrared pulse-modulation remote control device are chosen such that the baud rates ensures a reliable communication with the infrared receiver of the controlled appliance.

The invention relates to a wireless communication system comprising a transmitter for transmitting an infrared (IR) or radio-frequency (RF) signal and a receiver for receiving the signal, wherein both the transmitter and the receiver have a UART (Universal Asynchronous Receiver Transmitter). The transmitter comprises a modulator for modulating data to create the signal, and the receiver comprises a demodulator for demodulating the signal received and a data interpreter for interpreting the data in the demodulated signal. The system relates especially, but not exclusively, to consumer electronics (CE) equipment.

Such wireless communication systems are known. In such systems, a mobile station (e.g., a remote control device) comprising the transmitter, communicates with an apparatus that accommodates the receiver (e.g., a settopbox). The data in the known systems is transported in the NRZ (non-return to zero) format. A wireless RS-232 data-link may be established by connecting the transmitter and receiver directly to a serial RS-232 port. An example of such a system is a Sejin WEB-TV system.

The data information communicated is usually in the form of NRZ signals, meaning a data stream with no restrictions on the number of consecutive ones and zeros. NRZ data can be considered as a sequence of rectangular pulses. In the known devices all data is in accordance with the RS-232 standard data format. In this format the signal is composed of sequences of 8 data bits, 1 starting bit and 1 or 2 stop bits. In total, therefore, each character comprises 10 or 11 bits, each bit being either a “zero” (also called space) or a “one” (also called a mark).

U.S. Pat. No. 5,557,751 discloses a system using a UART transmission scheme. A serial communication circuit supports transmission for infrared communications over different IR protocols. The system comprises a set of buffers and a serial control circuit for transmitting and receiving data into and out of a computer system. The control circuit includes counter mechanisms for determining the amount of information in the buffers and when to start processing.

In the standard RS-232 data format and the standard UART data format for establishing a direct link between transmitter and receiver through wireless transmission channel signal modulation, signals are (de-) modulated to transfer said data. However, one or more of the following problems typically arise when transmitting and receiving this modulated data: noise and interference susceptibility; data bit errors; sensitivity decrease due to AGC (automatic gain control) tuning in IR receivers; high power consumption in the IR transmitter stage.

It is an object of the present invention to provide an improved link quality in a wireless communication system.

According to a first aspect of the present invention the above and other objects are fulfilled by a wireless communication system that comprises an apparatus with a transmitter for transmitting a signal in a wireless fashion to a receiver. The apparatus further comprises a UART for encoding data, and a modulator for pulse-modulating the encoded data on a carrier and transferring the modulated encoded data to the transmitter. The baud rate of transmitting complies with the following conditions:

1/baud rate>MIN_BURST·T1,

x/baud rate<MAX_ENV_ONTIME,

1/baud rate>MIN_ENV_OFFTIME,

wherein MIN_BURST is the minimum burst length admitted by the receiver; T1 is a frequency period of the carrier; MAX_ENV_ONTIME is the maximum envelope on-time admitted by the receiver; MIN_ENV_OFFTIME is the minimum envelope off-time admitted by the receiver; and x is the maximum number of consecutive high bits, including a start bit if any, a stop bit if any, and parity bit, if any.

A UART provides a means of sending and receiving bytes serially over a wired 2-line connection at a fixed data rate, the baud rate. Typically, in the UART, each byte is enhanced with a start bit and a stop bit and may also be enhanced with a parity bit at the transmitting end, i.e. typically by the transmitter. At reception, the data bits are sampled with the baud rate clock. The start bit, stop bit and any parity bits are removed and the data byte is placed in a buffer. The modulation is preferably a pulse modulation but also any other modulation that is based on the use of a carrier frequency, such as Amplitude Modulation or Frequency Modulation, may be used.

It is an advantage of using UART coding and encoding schemes that higher data rates for infrared transmission may be obtained without extensive software coding and fast real time software processing. However, with this communication system, the burst length of the pulse-modulated signal may vary, depending on the content of the data stream. To avoid that a burst length variation influence the systems ability for distinguishing the signals, and influence the noise and interference susceptibility at the receiver, the baud rate setting is selected to be in accordance with the receiver. Thus a special scheme for the baud rate setting is selected. It is, therefore, preferred that the baud rate and the carrier frequency are selected so that the time for a single bit is greater than the minimum burst length (MIN_BURST) multiplied by the carrier frequency period (T1), thus it is preferred that:

t_{bit}=1/baud rate>MIN_BURST·T1, (1)

Furthermore, the baud rate, parity bit, start bit and stop bit settings should be selected so that the time for the maximum number of consecutive ‘high’-bits does not exceed the maximum envelope on-time. Assuming that there is an active high signal polarity, no parity bit, a high start bit, eight high data bits and a low stop bit, then the maximum number of consecutive high bits will be 9. This will give the expression:

x·t_{bit}=x/baud rate<MAX_ENV_ONTIME, (2)

wherein x in this case equals 9. When the maximum envelope on-time is not exceeded, there will be no restriction on the envelope duty cycle in this baud rate setting scheme. The baud rate is preferably further selected so that the time for a single bit is greater than the minimum separation time between two consecutive bursts (the minimum envelope off-time):

t_{bit}=1/baud rate>MIN_ENV_OFFTIME, (3)

When these conditions (1) to (3) are fulfilled the infrared pulse-modulation (PM) receiver has an increased sensitivity and enhanced immunity against ambient infrared disturbances.

In an embodiment of the invention, the apparatus comprises a remote control device for remote control of, e.g., an appliance via infrared. The appliance accommodates the receiver, or is functionally coupled thereto. Preferably, the apparatus has a checksum function for providing a checksum with each data message transmitted in the signal. Preferably, the apparatus is programmable with respect to the baud rate of transmitting. In case there are two or more receivers for control of two or more appliances, the apparatus is programmable with respect to a respective value of the baud rate of transmitting, depending on a respective one of the receivers in case there are multiple receivers.

According to a second aspect of the invention, a method is provided of enabling to program an apparatus that has a transmitter for transmitting a signal in a wireless fashion to at least one receiver. The apparatus has a UART for encoding data, and a modulator for modulating the encoded data on a carrier and transferring the modulated encoded data to the transmitter. The method comprises providing a service to select a baud rate of transmitting that complies with following conditions:

1/baud rate>MIN_BURST·T1,

x/baud rate<MAX_ENV_ONTIME,

1/baud rate>MIN_ENV_OFFTIME,

the relevant quantities having been defined above.

In an embodiment, the apparatus is to transmit a further signal to a further, second, receiver using a further carrier that may, but need not, be different from the carrier mentioned above. The method comprises providing the service to select a further baud rate of transmitting complying with following conditions:

1/(further baud rate)>further MIN_BURST·T1′;

x′/(further baud rate)<further MAX_ENV_ONTIME;

1/(further baud rate)>further MIN_ENV_OFFTIME;

wherein the further MIN_BURST is the minimum burst length admitted by the further receiver; T1′ is a frequency period of the further carrier; the further MAX_ENV_ONTIME is the maximum envelope on-time admitted by the further receiver; the further MIN_ENV_OFFTIME is the minimum envelope off-time admitted by the further receiver; and x′ is the maximum number of consecutive high bits, including a start bit if any, a stop bit if any, and parity bit, if any. Preferably, the service is provided via a data network. As the type of receiver determines the values of the relevant parameters, the service could request the user to specify the appliances that are to cooperate with the apparatus accommodating the transmitter, so as to be able to provide the appropriate settings with which to program the apparatus.

Within the context of services see, e.g., the following:

U.S. Ser. No. 09/519,546 (attorney docket US 000014) filed Mar. 6, 2000 for Erik Ekkel et al., for PERSONALIZING CE EQUIPMENT CONFIGURATION AT SERVER VIA WEB-ENABLED DEVICE, published as WO0154406 and incorporated herein by reference. This patent document relates to facilitating the configuring of consumer electronics (CE) equipment by the consumer by means of delegating the configuring to an application server on the Internet. The consumer enters his/her preferences in a specific interactive Web page through a suitable user-interface of an Internet-enabled device, such as a PC or set-top box or digital cell phone. The application server generates the control data based on the preferences entered and downloads the control data to the CE equipment itself or to the Internet-enabled device.

U.S. Ser. No. 09/653,784 (attorney docket US 000220) filed Sep. 1, 2000, for Erik Ekkel et al., for STB CONNECTS REMOTE TO WEB SITE FOR CUSTOMIZED CODE DOWNLOADS, published as WO0154292 and incorporated herein by reference. This patent document relates to marketing a set top box (STB) together with a programmable remote. The remote has a dedicated button to connect the STB to a specific server on the Internet. The consumer can notify the server of his/her other consumer's equipment, which he/she desires to be controllable through the same remote as the one that came with the STB. The server downloads to the STB data representative of the relevant control codes. The STB is provided with means to program the remote with these codes. In return the server has obtained detailed and accurate information about this consumer's equipment. A reliable customer base can thus be built for streamlining Help Desk operations.

U.S. Ser. No. 09/686,572 (attorney docket US 000183) filed Oct. 10, 2000, for Tom Dubil et al., for CONTROL CODES FOR PROGRAMMABLE REMOTE SUPPLIED IN XML FORMAT, published as WO0231978 and incorporated herein by reference. This patent document relates to an Internet service that makes available control codes for use on a programmable universal remote. The remote controls CE equipment through IR or RF commands. A server supplies the control codes as XML data that gets processed at the receiver's set top box or PC, or the remote itself, for being properly installed on the remote.

The data transmitted may be a data stream comprising a number of bytes or characters, each byte or character comprising a number of bits. A data stream may also be termed a message.

In an embodiment, the signals transmitted are infrared signals, but any other types of signals capable of being transmitted between a guest and a host, such as RF or ultrasound signals may be used.

In a preferred embodiment, the system further comprises a message payload checksum mechanism that is implemented in, e.g., the software of the system. The mechanism is configured to add a checksum to a message, preferably each message, at the transmitting end and validate the checksum at the receiving end for verifying the integrity of the message.

The transmitter may therefore comprise a checksum function for providing a checksum with each data message transmitted and the receiver may comprise a corresponding checksum function to verify the checksum of each data message received from the transmitter. The message payload checksum mechanism verifies the message integrity and the message are rejected if the checksum deviates from an expected checksum.

In one embodiment of the invention the demodulator is embedded in the receiver.

It is preferred that the transmitter further generates a carrier frequency signal for sampling the message in the modulator, so that the encoded signal is pulse-modulated by providing the carrier frequency signal and the encoded signal to a sampler.

It is envisaged that the system and the method also may be used with bi-directional communication. To this end, the apparatus may further comprise another receiver, another demodulator for demodulating the signals and a UART for decoding the demodulated received signals. The appliance accommodating the first-mentioned receiver may further comprise another transmitter for transmitting the signals, another UART for encoding the data, and another modulator for modulating the encoded data and transferring the modulated encoded data to the other transmitter. The system may hereby allow for bi-directional communication. For bi-directional communication, a 2-way protocol may include the special scheme for the baud rate setting as described by above.

A pulse modulation technique as described herein may be used with a number of wireless devices, such as wireless infrared devices, for PCs, CEs and STBs, comprising handheld PDAs, remote control devices, wireless input and control devices, wireless display devices, etc.

The invention is explained in further detail, by way of example and with reference to the accompanying drawings wherein:

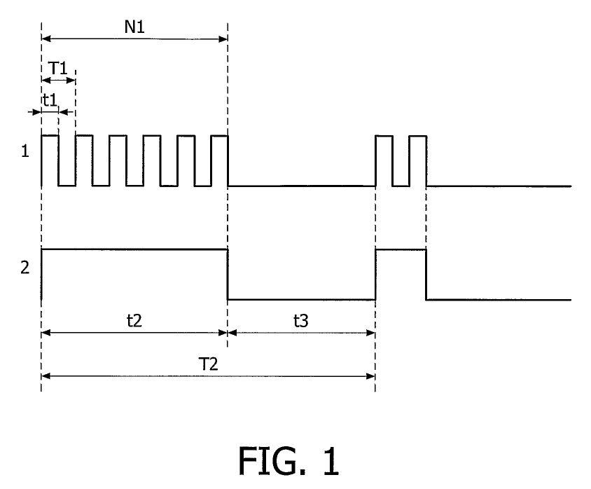

FIG. 1 shows an infrared pulse-modulated signal

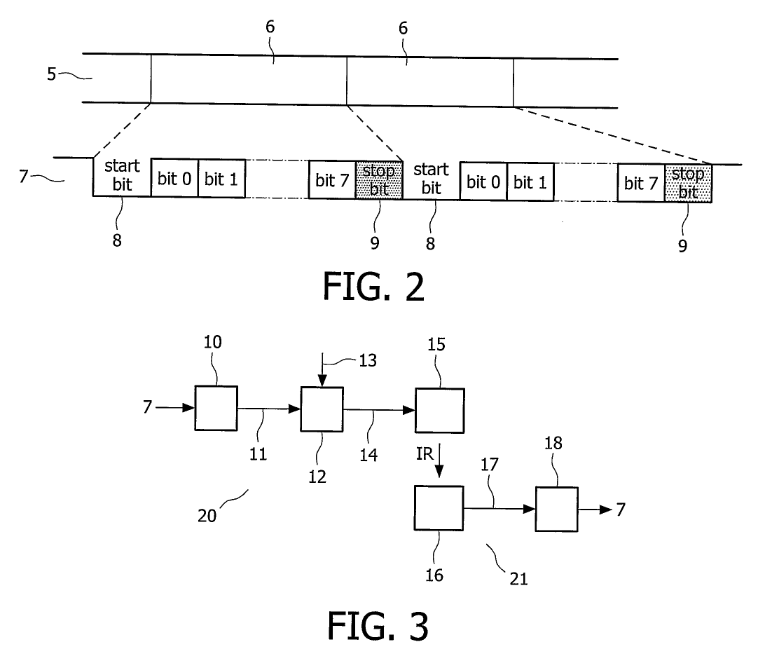

FIG. 2 shows UART encoding,

FIG. 3 shows schematically a communication system with UART encoded pulse modulation,

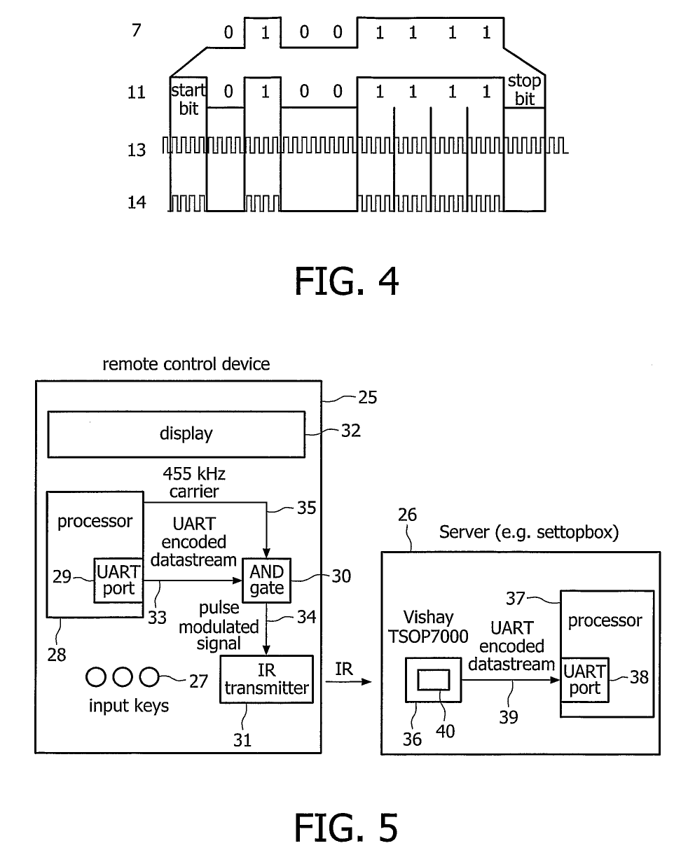

FIG. 4 shows the pulse modulation scheme of the system in FIG. 3,

FIG. 5 shows an example of a communication system with UART encoded pulse modulation schemes; and

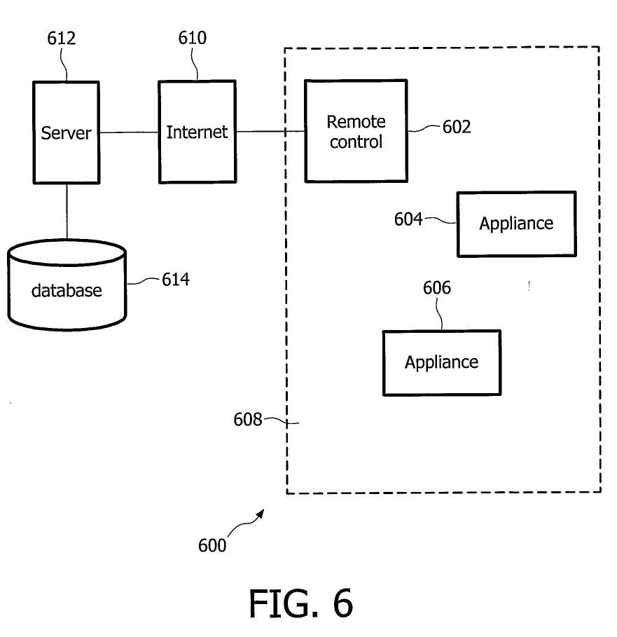

FIG. 6 is a diagram of a system in the invention.

In FIG. 1, an infrared pulse-modulated signal 1 is shown and the IR pulse-modulated signal envelope 2 is shown below this signal. The pulse-modulated signal is characterized by the following parameters:

| | | |
|---|---|---|
| Carrier frequency: | $\frac{1}{T 1}$ | [Hz] |
| Carrier duty cycle: | $\frac{t 1}{T 1} \cdot 100$ | [%] |
| Burst length: | N1 | [carrier cycles] |
| Envelope on-time: | t2 | [sec] |
| Envelope off-time | t3 | [sec] |
| Envelope duty cycle: | $\frac{t 2}{T 2} \cdot 100$ | [%] |

The burst length refers to the number of pulses of the carrier. A digital word may consist of several bursts and gaps between the bursts. Two consecutive words are separated by a “pause time”. The envelope on-time refers to the time period wherein a burst occurs. The envelope off-time refers to the time period that the burst is absent (the gap) before the next burst occurs. For the system to have a sufficient sensitivity and enhanced immunity against ambient infrared disturbances, the invention uses a specific pulse modulation scheme. The distinguishing factors or marks between data, on the one hand, and disturbances, on the other hand, are carrier frequency, burst length and the envelope duty cycle.

FIG. 2 shows a UART encoding scheme. The UART provides a means of sending and receiving bytes serially over a wired 2-line connection at a fixed data rate, the baud rate. A data stream 5 is shown comprising a number of bytes 6, and the UART encoded data stream 7 is shown below. At the sending end each data byte 6 is enhanced with a startbit 8, stopbit 9 and may also be configured with a parity bit. Each bit is transmitted serially at the pace of the baud rate clock. At the receiving end, the transition between the startbit 8 and stopbit 9 synchronizes the baud rate clock and the databits are sampled with the baud rate clock upon reception. The start bit 8, stop bit 9 and any parity bits are removed and the databyte 6 is placed in a buffer. This processing of the databytes is performed by the embedded UART port hardware, and no coding/decoding software routines are required for this.

To increase the data rates for infrared transmission, conventional pulse modulation schemes for infrared use a fixed-pulse coding pattern. Contrary to this the UART encoding of the invention as described above should be used. This is illustrated with reference to FIG. 3. To be able to gain higher data rates for transmission each byte should, at the transmitting end (the guest 20) be encoded with a UART 10. The encoded data stream 11 is then pulse-modulated by sampling at the carrier frequency 13 of the infrared PM receiver by a sampler 12, and the encoded, modulated datastream 14 is then transmitted by transmitter 15 over infrared. Such a sampler 12 may be a simple Boolean AND or OR function and'ing or or'ing the carrier frequency with the UART encoded datastream 11. At the receiver end (the host 21), the infrared PM receiver 16 will demodulate the signal by an embedded demodulator (not shown), and the demodulated encoded datastream 17 will then be decoded by UART 18 into the original data stream 7.

Since a UART hardware encoder/decoder and a hardware sampler are used for modulation, no software coding, modulating and decoding is needed, so that no fast real-time software processing is required.

FIG. 4 shows the UART encoded pulse modulation scheme, the pulse scheme for data stream 7 (byte), UART encoded datastream 11 (byte), carrier frequency 13 and pulse modulated signal 14.

When using this communication system, the burst length of the pulse-modulated signal may vary, depending on the content of the data stream. In order to obtain a high sensitivity and disturbance immunity for the infrared PM receiver, a special baud rate setting according to expressions 1-3 is provided.

With a baud rate setting that meets the conditions laid down above, the infrared PM receiver will have a high sensitivity and enhanced immunity against ambient infrared disturbance. Consequently, a link quality and working range similar to that of systems with a traditional pulse modulation scheme may be obtained by using this pulse modulation technique.

The communication system with UART encoded pulse modulation scheme does not check the pulse pattern as is typically the case with fixed pulse patterns, but samples the encoded UART data stream at the (theoretical) center of each incoming bit at decoding.

This may eliminate any pulse stretching effects caused by the demodulator of the IR receiver. However, this is only true when the range is limited and the carrier frequency/baud rate ratio is sufficiently high. To avoid errors at extended range due to disturbance and therefore the need for a new transmission of faulty signals or byte encoding and thereby obtaining a lower throughput rate, it is preferred to use the above baud rate setting.

To check the message integrity, a message payload checksum mechanism may be provided so that a message check sum is added to each message. This checksum is then validated at the receiving end to check the message integrity. A checksum result different from the expected will cause a message to be rejected.

FIG. 5 shows a remote control device or guest 25, and a server or host 26, such as a set-top-box. The remote control device has a 455 kHz wireless infrared link with the server 26. The remote control device comprises input keys 27 to receive input from a user, a display 32 for visual output to the user, a processor 28 for processing all device functions, an embedded UART 29 for encoding datastreams, a sampler 30 in the form of an AND-gate to pulse-modulate the UART encoded data stream 33, and an IR transmitter 31 to send the pulse-modulated signal 34 through infrared.

Besides the basic device functions, the software in the remote control generates a 455 kHz carrier 35 and provides a checksum with each message that is to be sent through infrared.

The server 26 comprises a 455 kHz infrared PM receiver 36 with an embedded demodulator 40, a processor 37 for processing all the device functions, an embedded UART port 38 for decoding the UART encoded datastream 39, and several other IO functions and peripherals relevant for the operation of the device. The software in the server 26 further comprises a function to check the checksum of each incoming message that is sent through infrared and to reject any messages that are invalid. In case of an invalid message, the user will have to re-send the message.

It is envisaged that even though the system, here described, comprises a one-way infrared link between the transmitter at the remote control device and a receiver at the server side, the modulation technique may equally be applicable for a two-way infrared link, with be-directional transmission according to the pulse modulation technique.

The baud rate setting is dependent on the brand and type of the infrared PM receiver. The infrared receiver is a 455 kHz infrared PM receiver, the Vishay TSOP7000, with the following parameters:

The carrier frequency CARR_FREQ=455 kHz, the minimum burst length MIN_BURST=10 cycles, the maximum envelope on-time, MAX_ENV_ONTIME=500 μs, the minimum envelope duty cycle MIN_ENV_DC=25%, the minimum separation time between two consecutive bursts, MIN_ENV_OFFTIME=26 μs and the carrier frequency duty cycle between MIN_CARR_DC=10% and MAX_CARR_DC=50%.

The settings for the system shown in FIG. 4 may be defined using the baud rate setting described above, wherein the expressions become:

t_{bit}=1/baud rate>MIN_BURST·T1=10·1/(455·10³)

[symbol]

t_{bit}=1/baud rate>22 μs [symbol] baud rate<45.5 kbps (1′)

In case there is no parity bit, one startbit and one stop bit expression 2 becomes:

9·t_{bit}=9/baud rate<MAX_ENV_ONTIME=500 μs

[symbol]

t_{bit}=1/baud rate<500 μs/9=56 μs [symbol] baud rate>18 kbps (2′)

Furthermore, expression 3 becomes:

t_{bit}=1/baud rate>MIN_ENV_OFFTIME=26 μs [symbol] baud rate<38.4 kbps. (3′)

Expressions 2 and 3 form the limiting factors. It may therefore be concluded that the baud rate must be between 18 and 38.46 kbps, with the settings of 8 databits, 1 stopbit, and no parity bit. When taking into account all system tolerances, such as jitter on the output of the infrared PM receiver, tolerance on the carrier signal and baud rate clock, etc., it is preferred to have a baud rate setting close to the minimum baud rate to achieve optimum link quality. A baud rate setting close to the maximum baud rate will give poorer link quality due to message rejections, so the advance of the high baud rate may be cancelled. Hence, it is preferred to select the baud rate setting close to the minimum baud rate.

FIG. 6 illustrates the service aspect of the invention. FIG. 6 is a block diagram of a system 600, comprising an apparatus 602 with a remote control device similar to device 25 in FIG. 5. Remote control device 602 is programmable for control of appliances 604 and 606 in a home network environment 608 of the end user. Device 602 is, for example, a universal programmable remote control device with a touch screen for a user-interface. Device 602 and appliances 604-606 each have a UART and can communicate wirelessly using a pulse modulation technique as discussed above. Assume that the user wants to have remote control device 602 programmed for operational use with appliances 604-606 according to the invention. The user connects via the Internet 610 to a server 612. The connection is illustrated as being a direct connection from remote control device 602 with the Internet 610. If device 602 is not network-enabled, connection to server 612 can be made with another piece of equipment (not shown) such as a PC or digital telephone. Server 612 has access to a database 614 that lists the types and versions of appliances controllable in a wireless fashion using the UART approach as discussed in the background art above, and their relevant operational parameters. The type and version of each of appliances 604-606 determines the capabilities of the respective appliance's wireless receiver. Now, if the user specifies to server 612 the type and version of appliance 604 and of appliance 606 (e.g., brand, type of functionality, model number etc.), server 612 consults database 614 to find the proper values of one of more of the quantities mentioned above: MIN_BURST; T1; MAX_ENV_ONTIME; MIN_ENV_OFFTIME; and x (the maximum number of consecutive high bits). Once found, the baud rate settings are determined and forwarded as data to the user via the Internet 610. The data is either downloaded directly to device 602 if the latter is network-enabled, or temporarily stored at the other piece of equipment (not shown) for programming device 602 later on. Alternatively, device 602 has a configuration mode wherein the user can simply select the baud rate setting per appliance. In that case, server 612 returns the proper numerical values in a user readable format so that the user him/herself can set the relevant baud rate at the proper value.

1. Wireless communication system comprising an apparatus (20, 25) with a transmitter (15,31) for transmitting a signal in a wireless fashion to at least one receiver (16,36), the apparatus further comprising a UART (10, 29) for encoding data, and a modulator (12, 30) for modulating the encoded data on a carrier and transferring the modulated encoded data to the transmitter (15, 31), a baud rate of transmitting complying with following conditions:
1/baud rate>MIN_BURST·T1,
x/baud rate<MAX_ENV_ONTIME,
1/baud rate>MIN_ENV_OFFTIME,
wherein:
MIN_BURST is the minimum burst length admitted by the receiver;
T1 is a frequency period of the carrier;
MAX_ENV_ONTIME is the maximum envelope on-time admitted by the receiver;
MIN_ENV_OFFTIME is the minimum envelope off-time admitted by the receiver;
x is the maximum number of consecutive high bits, including a start bit if any, a stop bit if any, and parity bit, if any.

2. The system of claim 1, wherein the signal comprises an infrared signal.

3. The system of claim 1, wherein the apparatus comprises a remote control device.

4. The system of claim 3, wherein the apparatus has a checksum function for providing a checksum with each data message transmitted in the signal.

5. The system of claim 1, wherein the apparatus is programmable with respect to the baud rate of transmitting.

6. The system of claim 1, wherein the apparatus is programmable with respect to a respective value of the baud rate of transmitting depending on a respective one of the receivers in case there are two or more receivers.

7. The system of claim 1, wherein the apparatus is operative to transmit a further signal to a further receiver using a further carrier, and wherein a further baud rate of transmitting the further signal complies with following conditions:
1/(further baud rate)>further MIN_BURST·T1′;
x′/(further baud rate)<further MAX_ENV_ONTIME;
1/(further baud rate)>further MIN_ENV_OFFTIME;
wherein:
the further MIN_BURST is the minimum burst length admitted by the further receiver;
T1 is a frequency period of the further carrier;
the further MAX_ENV_ONTIME is the maximum envelope on-time admitted by the further receiver;
the further MIN_ENV_OFFTIME is the minimum envelope off-time admitted by the further receiver;
x′ is the maximum number of consecutive high bits, including a start bit if any, a stop bit if any, and parity bit, if any.

8. A method of enabling to program an apparatus (20, 25, 602) that has a transmitter (15,31) for transmitting a signal in a wireless fashion to at least one receiver (16,36; 604, 606), a UART (10, 29) for encoding data, and a modulator (12, 30) for modulating the encoded data on a carrier and transferring the modulated encoded data to the transmitter (15, 31), the method comprising:
providing a service to determine a baud rate of transmitting that complies with following conditions:
1/baud rate>MIN_BURST·T1,
x/baud rate<MAX_ENV_ONTIME,
1/baud rate>MIN_ENV_OFFTIME,
wherein:
MIN_BURST is the minimum burst length admitted by the receiver;
T1 is a frequency period of the carrier;
MAX_ENV_ONTIME is the maximum envelope on-time admitted by the receiver;
MIN_ENV_OFFTIME is the minimum envelope off-time admitted by the receiver;
x is the maximum number of consecutive high bits, including a start bit if any, a stop bit if any, and parity bit, if any.

9. The method of claim 8, for programming the apparatus to transmit a further signal to a further receiver using a further carrier, the method comprising providing the service to determine a further baud rate of transmitting complying with following conditions:
1/(further baud rate)>further MIN_BURST·T1′;
x′/(further baud rate)<further MAX_ENV_ONTIME;
1/(further baud rate)>further MIN_ENV_OFFTIME;
wherein:
the further MIN_BURST is the minimum burst length admitted by the further receiver;
T1′ is a frequency period of the further carrier;
the further MAX_ENV_ONTIME is the maximum envelope on-time admitted by the further receiver;
the further MIN_ENV_OFFTIME is the minimum envelope off-time admitted by the further receiver;
x′ is the maximum number of consecutive high bits, including a start bit if any, a stop bit if any, and parity bit, if any.

10. The method of claim 8, wherein the service is provided via a data network (610).
